(19) United States
(12) Patent Application Publication
(10) Pub. No.: US 2026/0122183 A1
(43) Pub. Date: Apr. 30, 2026

(54) ARTIFICIAL INTELLIGENCE AUGMENTED VOICE RECOGNITION PLATFORM FOR EMERGENCY SERVICES USING 5G ORAN-BASED PUSH TO TALK OVER CELLULAR SERVICE

(71) Applicant: DISH Wireless L.L.C., Englewood, CO (US)

(72) Inventors: Mihir Bhatt, Denver, CO (US); Bassem Abi-Farah, Littleton, CO (US)

(21) Appl. No.: 18/926,131

(22) Filed: Oct. 24, 2024

(51) Int. Cl. H04M 3/527; G10L 15/02; G10L 15/22; G10L 25/48; H04W 4/029; H04W 4/10; H04W 4/90

(52) U.S. Cl. CPC H04M 3/527; G10L 15/02; G10L 15/22; G10L 25/48; H04W 4/029; H04W 4/10; H04W 4/90

(57) ABSTRACT

Systems and methods to perform artificial intelligence (AI) augmented voice recognition within telecommunications networks. One system includes a processing system including one or more electronic processors. The processing system may be configured to: receive audio data captured with a user equipment (UE) and metadata corresponding to the audio data, where the UE is a push-to-talk over cellular enabled device. The processing system may be configured to execute an AI model to evaluate the audio data and the metadata to determine a circumstantial context of the audio data. The processing system may be configured to control, based on the circumstantial context, a response system to execute an automated response protocol.

### BACKGROUND

Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to artificial intelligence (AI) augmented voice recognition platform for Emergency services using a 5G Open Radio Access Network (ORAN) based push to talk over cellular (PTToC) services to ensure high availability and increased reliability of Emergency communications such as, e.g., within a mission critical PTToC service.

According to one aspect of the present disclosure, a system to implement an AI-augmented voice recognition platform within telecommunication networks. The system may include a processing system including one or more electronic processors. The processing system may be configured to receive, via a telecommunications network, audio data captured with a user equipment (UE), where the UE may be a push-to-talk over cellular (PTToC) enabled device. The processing system may be configured to receive, via the telecommunications network, metadata that corresponds to the audio data, where the metadata may be generated based on a preprocessing operation executed by the UE with respect to the audio data. The processing system may be configured to execute an AI model to evaluate the audio data and the metadata to determine a circumstantial context of the audio data. The processing system may be configured to determine, based on execution of the AI model, the circumstantial context of the audio data. The processing system may be configured to control, based on the circumstantial context, a response system to execute an automated response protocol.

According to another aspect of the present disclosure, a method to implement an AI-augmented voice recognition platform within telecommunication networks. The method may include receiving, with a processing system including one or more electronic processors, using a voice over new radio (VoNR), an audio data package, the audio data package including audio data captured with a push-to-talk (PTT) device, where the PTT device may be a push-to-talk over cellular (PTToC) enabled device. The method may include executing, with the processing system, an AI model to determine a circumstantial context of the audio data from the audio data package. The method may include determining, with the processing system, that the circumstantial context of the audio data triggers an automated response protocol. The method may include executing, with the processing system, based on the circumstantial context, an automated response pursuant to the automated response protocol.

According to another aspect of the present disclosure, a non-transitory computer-readable medium is provided. The non-transitory computer-readable medium stores instructions that, when executed by one or more electronic processors of a processing system in a telecommunications network, may cause the processing system to perform operations comprising: receiving, over a fifth generation (5G) telecommunications network, using voice over new radio (VoNR), audio data captured with a push-to-talk over cellular (PTToC) device; receiving, over the 5G telecommunications network, using VoNR, metadata corresponding to the audio data; providing the audio data and the metadata to an artificial intelligence (AI) model, the AI model configured to extract a plurality of voice features from the audio data and the metadata; determining that one or more voice features of the plurality of voice features indicate an event; and, responsive to determining that the one or more voice features of the plurality of voice features indicate the event, controlling execution of an automated response associated with the event.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 schematically illustrates an example of a server in accordance with various aspects of the present disclosure.

FIG. 4 schematically illustrates an example of user equipment in accordance with various aspects of the present disclosure.

FIG. 5 schematically illustrates an example of a push-to-talk (PTT) server in accordance with various aspects of the present disclosure.

FIG. 6 is a flowchart of an example method to artificial intelligence (AI) augmented voice recognition within telecommunications networks in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (UE) (e.g., mobile phones and the like). As another example, the wireless communication networks described herein may comply with other industry standards, such as, e.g., the Distributed Radio Access Network (Distributed RAN or D-RAN) or the like. In some configurations, the wireless communication network may be another type of wireless network, such as, for example, a sixth generation (6G), wireless network.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

Accordingly, the technology disclosed herein provides methods and systems to perform artificial intelligence (AI) augmented voice recognition within telecommunication networks. In some configurations, the technology disclosed herein provides an artificial intelligence (AI) voice recognition platform for Emergency services using a 5G ORAN-based push-to-talk over cellular (PTToC) service. A Mission Critical PTToC service is implemented in cases of unforeseen events that may, e.g., affect the survival of people in affected areas. To ensure the high availability and to increase the reliability of such communications, the technology disclosed herein augments those communications with AI capabilities. In some examples, the technology disclosed herein may augment AI functionality with respect to PTToC services or communications such that, e.g., the technology disclosed herein may detect a status of voice communications of PTT communications using a Voice over New Radio (VoNR) based 5G-driven low latency voice transmission. In some configurations, the technology disclosed herein may detect status of voice communications based on various voice or audio features, such as, e.g., tonal pitch, volume, word choice, etc. By implementing the technology disclosed herein within a 5G telecommunications network using VoNR, the technology disclosed herein allows data to be captured at a much higher rate (as compared to, e.g., voice over long term evolution (VoLTE) or other channels) to enable embedding of AI in real-time (or near real-time) voice capture for augmentation and tonal analysis.

Detecting emergency situations without the need to send a complete message is primordial in cases where the user is encountering difficulties in conveying messages due to various factors, such as, e.g., a non-availability of destination user, a breakdown or disruption in communications, or a presence of a perpetrator. As described in greater detail herein, the technology disclosed herein provides near real-time audio analysis that may result in the triggering of emergency communications.

In order to ensure an efficient and reliable system for implementation of such features, the technology disclosed herein may reside on top of a PTT Application service and may facilitate handshakes with a cloud-native 5G Open RAN using advanced APIs. Accordingly, the technology disclosed herein may enable capture of voice communication attempts using a microphone of a PTT device connected to the 5G network. The PTT application may include features which enable voice recording and automated triggering of emergency channels on a PTT server, which may include, e.g., existing land mobile radio (LMR) networks, E911 networks, 5G network connectivity outside of WiFi, etc. In some configurations, the technology disclosed herein may implement an AI engine that may recognize voice patterns using recorded voice or PTT call attempts to alert the authorities accordingly. In some configurations, the technology disclosed herein may improve with more data and may enable additional techniques for interception or emergency triggering using pattern detection and tonality, and word choice (or an absence of one or more words).

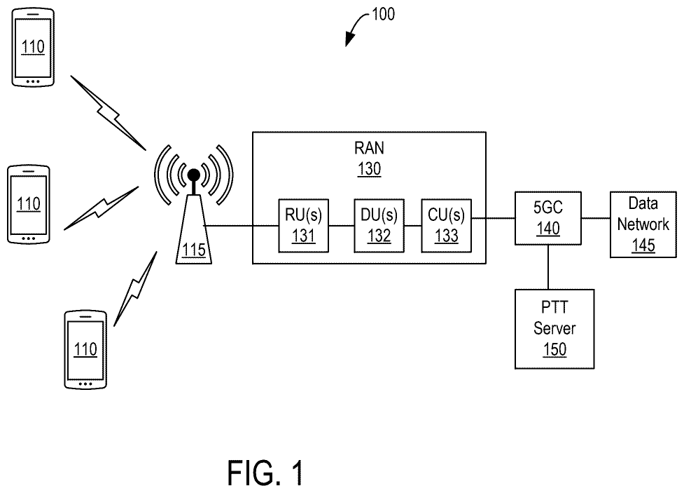

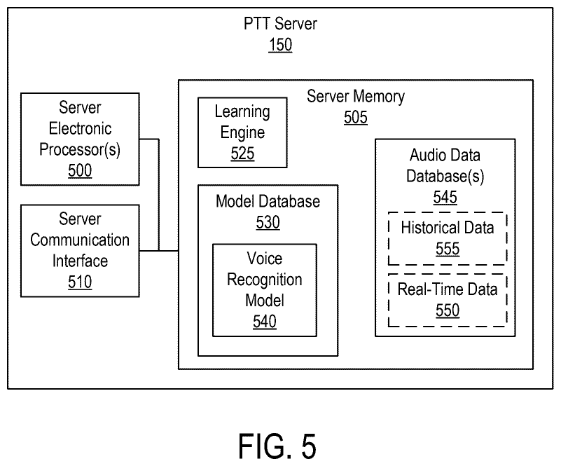

FIG. 1 illustrates an example of a telecommunications network 100 in accordance with various aspects of the present disclosure. In the telecommunications network 100 of FIG. 1, one or more user equipment (UE) 110 may be connected to a wireless access point 115, which in turn may be connected to a radio access network (RAN) 130, including, e.g., one or more radio units (RUs) 131, distributed units (DUs) 132, centralized units (CUs) 133, or a combination thereof. In some configurations, the RAN 130 may be implemented as a virtualized RAN 130. As noted herein, the O-RAN model follows a virtualized model for a 5G wireless architecture in which 5G base stations (e.g., gNBs) are implemented using separate CUs, DUs, and RUs. In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Accordingly, in some configurations, the RAN 130 may be implemented in accordance with the O-RAN model, such that the RUs 131, the DUs 132, or CUs 133 may be O-RAN RUs, CUs, or DUs. The RAN 130 may provide a connection to a 5G core network (5GC) 140, which in turn may provide a connection to a data network 145, a PTT server 150, or a combination thereof. The data network 145 may be the Internet, an enterprise data network, combinations thereof, or the like. The PTT server 150 is described in greater detail herein with respect to FIG. 5. The wireless access point 115 and the RAN 130 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized. For instance, in some implementations, the telecommunication network 100 may be implemented using one or more virtualized RAN components, such as, e.g., one or more virtualized RUs, virtualized DUs, virtualized CUs, or a combination thereof. In some configurations, the telecommunication network 100 may be implemented pursuant to the O-RAN model, as described herein. Accordingly, in some instances, the telecommunications network 100 may be an O-RAN telecommunications network.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), a two-way radio, a walkie-talkie, or any computerized device capable of communicating via a cellular network. More generally, the UEs 110 can represent any type of device that has an incorporated 5G interface, such as, e.g., a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). In some configurations, the UEs 110 may support push-to-talk (or push-to-transmit) communications or technology. For instance, in some examples, the UEs 110 may be a PTT enabled device, such as, e.g., a walkie-talkie, a two-way radio, etc. In some configurations, the UEs 110 may be PTToC enabled devices. PTToC may refer to a service option in which subscribers may utilize a cellular phone (or another type of UE described herein) as a walkie-talkie. While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connects. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 131. The RU(s) 131 are configured to convert radio signals sent to and received from the antenna(s) into a digital signal. The wireless access point 115 is connected to the RAN components 130 via a fronthaul link over which the digital signals may be communicated. The DU(s) 132 may be connected to the CU(s) 133 via a midhaul link. The CU(s) 133 may be connected to the 5GC 135 via a backhaul link. While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU 132 and a number of RUs 131 (e.g., six RUs 131) assigned to it.

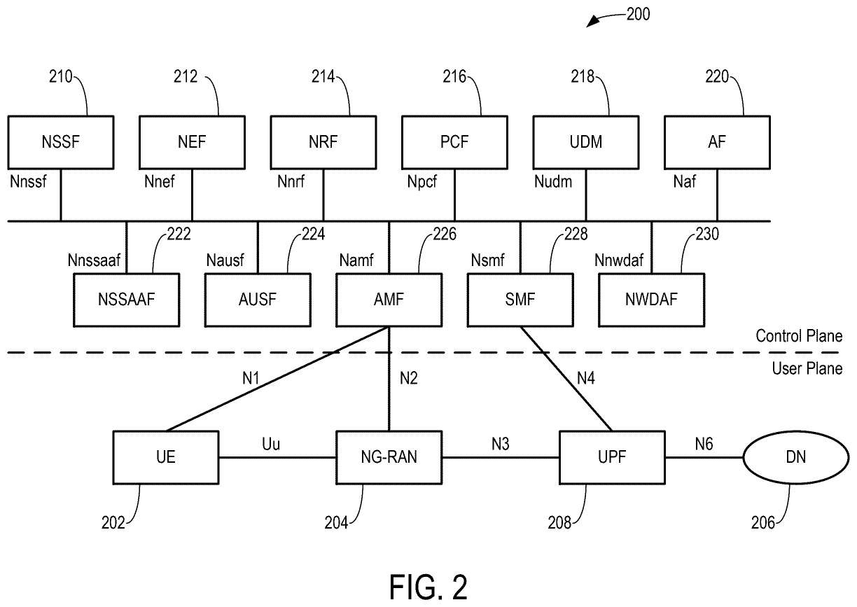

The 5GC 140 provides a plurality of 5G core functions. In the topology of a 5G NR cellular network, 5G core functions of 5GC 140 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within a regional data center (RDC) are described in more detail with regard to FIG. 2. The data network 145 may be the Internet, an enterprise data network, combinations thereof, or the like.

FIG. 2 illustrates an example architecture 200 for a telecommunications network (e.g., the telecommunications network 100 of FIG. 1) in accordance with various aspects of the present disclosure. In some instances, the architecture 200 may be a service-based architecture (SBA), such as, e.g., a SBA based on HTTP2. The architecture 200 may be divided between a control plane (CP) and a user plane (UP). The CP may include a plurality of CP network functions (NFs). The UP may include a UE 202 (e.g., one of the UEs 110 of FIG. 1) connected to an NG-RAN 204, and UP NFs (e.g., a User Plane Function (UPF) 208). In some implementations, using the architecture 200, the UE 202 may access a data network 206 (e.g., the data network 140 of FIG. 1). For ease of illustration, FIG. 2 only shows a single UE 202 being connected to the NG-RAN 204; however, in practical implementations, any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The SBA 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

For purposes of explanation, the technology disclosed herein will be described as being implemented in a 5G O-RAN network; however, in practice, the technology disclosed herein may be implemented with any RAN architecture (including, e.g., any virtualized RAN architecture). Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as described herein (e.g., including one or more individual electronic processors). A data center server is an example of such a processing system that may perform the methods described herein.

As described herein with respect to FIG. 1, the 5GC 140 provides a plurality of 5G core functions, which may reside and/or execute via one or more data centers (e.g., one or more NDCs or RDCs), including, e.g., one or more data center servers. For instance, in some configurations, the data center server(s) may store and execute a set of instructions for executing one or more NF as described herein. Additionally, in some embodiments, the data center server may be a local server located at corresponding cell site(s) (e.g., as part of an on-site computing platform of a corresponding wireless access point 115 or cell site). Alternatively, or in addition, in some embodiments, the data center server may be a remote cloud server located remotely from the corresponding cell site(s).

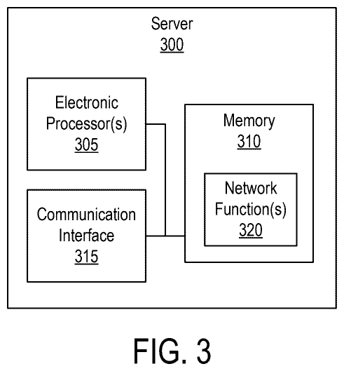

For example, FIG. 3 schematically illustrates an example server 300 (e.g., a data center server for the 5GC 140 of FIG. 1) according to some configurations. As illustrated in FIG. 3, the server 300 includes an electronic processor 305, a memory 310, and a communication interface 315. The electronic processor 305, the memory 310, and the communication interface 315 may communicate wirelessly, over one or more communication lines or buses, or a combination thereof. The server 300 may include additional, different, or fewer components than those illustrated in FIG. 3 in various configurations. The server 300 may perform additional or different functionality than the functionality described herein. Also, the functionality (or a portion thereof) described herein as being performed by the server 300 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The communication interface 315 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The electronic processor 305 includes one or more electronic processors (e.g., one or more microprocessors, one or more application-specific integrated circuits (ASICs), and/or one or more other suitable electronic device for processing data), and the memory 310 includes a non-transitory, computer-readable storage medium. The electronic processor 305 is configured to retrieve instructions and data from the memory 310 and execute the instructions. For example, as illustrated in FIG. 3, the memory 310 may store one or more network functions 320 (also referred to herein as the NFs 320). The NFs 320 may include, e.g., one or more of the network functions described herein, such as, e.g., with respect to FIG. 2.

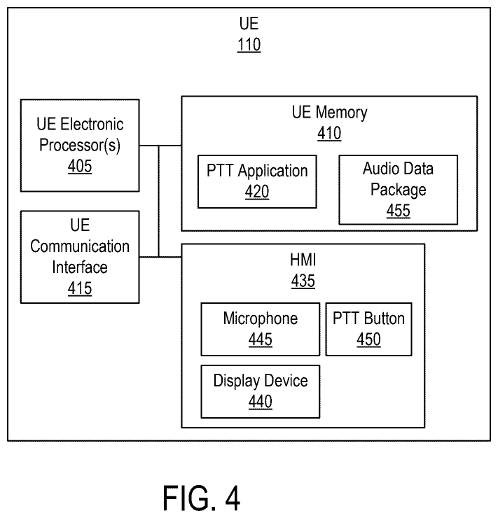

FIG. 4 schematically illustrates an example UE 110 according to some configurations. As illustrated in FIG. 4, the UE110 includes a UE electronic processor 405, a UE memory 410, a UE communication interface 415, and a human-machine interface (“HMI”) 435. The UE electronic processor 405, the UE memory 410, the UE communication interface 415, and the HMI 435 may communicate wirelessly, over one or more communication lines or buses, or a combination thereof. The UE 110 may include additional, different, or fewer components than those illustrated in FIG. 4 in various configurations. The UE 110 may perform additional or different functionality than the functionality described herein. Also, the functionality (or a portion thereof) described herein as being performed by the UE 110 may be performed by another component or device, distributed among multiple devices (e.g., as part of a cloud service or cloud-computing environment), combined with another component (e.g., another component of the telecommunications network 100), or a combination thereof.

The UE communication interface 415 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The UE electronic processor 405 includes one or more processors (e.g., one or more microprocessors, one or more application-specific integrated circuits (ASICs), and/or one or more other suitable electronic device for processing data), and the UE memory 410 includes a non-transitory, computer-readable storage medium. The UE electronic processor 405 is configured to retrieve instructions and data from the UE memory 410 and execute the instructions.

For example, as illustrated in FIG. 4, the UE memory 410 may store a push-to-talk (PTT) application 420. The PTT application 420 is a software application executable by the UE electronic processor 405 in the example illustrated and as specifically discussed below, although a similarly purposed module can be implemented in other ways in other examples. In some configurations, the PTT application 420 may be a dedicated software application locally stored in the UE memory 410 of the UE 110. As described in greater detail herein, the PTT application 420 (when executed by the UE electronic processor 405) may enable or facilitate PTT functionality (e.g., controlling the capture and transmission of audio data) in accordance with the technology disclosed herein.

The UE memory 410 may include additional, different, or fewer components in different configurations than illustrated in FIG. 4. Alternatively, or in addition, in some configurations, one or more components of the UE memory 410 may be combined into a single component, distributed among multiple components, or the like. Alternatively, or in addition, in some configurations, one or more components of the UE memory 410 may be stored remotely from the UE 110, or, in a remote database, another server, a remote user device, an external storage device, or the like.

As illustrated in FIG. 4, the UE 110 may include the HMI 435 for interacting with a user. The HMI 435 may include one or more input devices, one or more output devices, or a combination thereof. Accordingly, in some configurations, the HMI 435 allows a user to interact with (e.g., provide input to and receive output from) the UE 110. For example, the HMI 435 may include a keyboard, a cursor-control device (e.g., a mouse), a touch screen, a scroll ball, a mechanical button, a display device (e.g., a liquid crystal display (“LCD”)), a printer, a speaker, a microphone, etc.

In the illustrated example of FIG. 4, the HMI 435 includes a display device 440, a microphone 445, and a PTT button 450. The display device 440 may be included in the same housing as the UE 110 or may communicate with the UE 110 over one or more wired or wireless connections. As one example, the display device 440 may be a touchscreen included in a cellular phone, a smart wearable, a laptop computer, a tablet computer, etc. As another example, the display device 440 may be a monitor, a television, or a projector coupled to a terminal, desktop computer, or the like via one or more cables.

In some configurations, the HMI 435 may include the microphone 445. The microphone 445 may capture (or otherwise record) audio data (also referred to herein as “voice data”). In some configurations, the microphone 445 may capture audio data using 5G VoNR with ultra-low latency. In some examples, the microphone 445 may capture audio data continuously in real-time (or near real-time). In some configurations, the audio data may be time series data or a data stream of audio data (e.g., an audio data stream).

In some configurations, the HMI 435 may include the PTT button 450. A user may interact with the PTT button 450 in order to switch between a voice reception mode and a voice transmit mode. When the PTT button 450 is active (e.g., receiving an input or interaction from a user), the UE 110 may operate in a voice transmit mode, in which voice data is captured (via, e.g., the microphone 445) and transmitted to an external source or device. When the PTT button 450 is inactive (e.g., not receiving an input or interaction from a user), the UE 110 may operate in a voice reception mode, in which voice data is received from an external source or device and output to a user of the UE 110 (e.g., via a speaker or another type of output device of the UE 110). In some configurations, the PTT button 450 may be a physical button (or a mechanical button), such as, e.g., a momentary button. Alternatively, or in addition, in some configurations, the PTT button 450 may be a virtual or digital button, such as, e.g., a graphical representation or icon included in a user interface (or a graphical user interface) displayed via the display device 440. In such configurations, the PTT button 450 may be displayed to a user of the UE 110 via the display device 440 such that a user may interact with the PTT button 450 by selecting (via a cursor control device (e.g., a mouse), a touchscreen, etc.) the graphical representation or icon of the PTT button 450.

In some configurations, the PTT application 420 may control operation of the microphone 445. For instance, the PTT application 420 may control the microphone 445 such that the microphone 445 continuously captures (or otherwise records) audio data. In some examples, the PTT application 420 may control the microphone 445 to capture audio data regardless of whether the PTT button 450 is active or inactive. For instance, the microphone 445 may capture audio data when the PTT button 450 is not being interacted with (inactive) and when the PTT button 450 is being interacted with (active). Accordingly, in some configurations, the UE 110 may continuously monitor and capture voice input (e.g., as the audio data) using 5G VoNR with ultra-low latency.

In some configurations, the PTT application 420 may execute (or otherwise perform) one or more preprocessing functions on the audio data (e.g., as preprocessing operation(s)). For instance, in some configurations, the PTT application 420 may filter noise from the audio data, enhance clarity of the audio data, etc. Alternatively, or in addition, in some configurations, the PTT application 420 may generate metadata corresponding to the audio data. In some configurations, the metadata may indicate (or otherwise include) a feature or a characteristic of the audio data. A feature or characteristic of the audio data may include, e.g., a tonal pitch, a volume, a word choice, a voice pattern, an audio reverberation, etc.

In some configurations, as the audio data is captured by the UE 110 (via, e.g., the microphone 445), the PTT application 420 may determine a feature of the audio data and generate metadata indicative of that feature. In some configurations, the PTT application 420 may link or associate the metadata with the corresponding audio data. For example, the PTT application 420 may store the audio data in association with the corresponding metadata generated for the audio data in, e.g., the UE memory 410. In some examples, the PTT application 420 may aggregate (or otherwise compile) the audio data and the associated metadata as an audio data packet 455. As illustrated in FIG. 4, the audio data packet 455 may be stored in the UE memory 410.

As noted herein, in some configurations, the telecommunications network 100 may include the PTT server 150. In some instances, the PTT server 150 may be coupled to the 5GC 140, as illustrated in the example of FIG. 1. Accordingly, in some configurations, the PTT server 150 is a separate component from the 5GC 140 such that, e.g., the PTT server 150 resides on top of the 5GC 140. Alternatively, or in addition, in some configurations, the PTT server 150 may be included as a component or element of the 5GC 140.

As illustrated in FIG. 5, the PTT server 150 includes a server electronic processor 500, a server memory 505, and a server communication interface 510. The server electronic processor 500, the server memory 505, and the server communication interface 510 may communicate wirelessly, over one or more communication lines or buses, or a combination thereof. The PTT server 150 may include additional, different, or fewer components than those illustrated in FIG. 5 in various configurations. The PTT server 150 may perform additional or different functionality than the functionality described herein. Also, the functionality (or a portion thereof) described herein as being performed by the PTT server 150 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The server communication interface 510 may include a transceiver that communicates with other components of the telecommunications network 100, such as, e.g., the 5GC 140, the data network 145, the RAN 130, including, e.g., the RU(s) 131, DU(s) 132, or CU(s) 133, etc. over one or more communication networks or connections. The server electronic processor 500 includes one or more processors (e.g., one or more microprocessors, one or more ASICs, and/or one or more other suitable electronic device for processing data), and the server memory 505 includes a non-transitory, computer-readable storage medium. The server electronic processor 500 is configured to retrieve instructions and data from the server memory 505 and execute the instructions.

For example, as illustrated in FIG. 5, the server memory 505 may store a learning engine 525 and a model database 530. In some configurations, the learning engine 525 develops one or more models using one or more machine learning functions. Machine learning functions are generally functions that allow a computer application to learn without being explicitly programmed. In particular, the learning engine 525 is configured to develop an algorithm or model based on training data. As one example, to perform supervised learning, the training data includes example inputs and corresponding desired (for example, actual) outputs, and the learning engine 525 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 525 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 525 to ingest, parse, and understand data and progressively refine models.

Models generated by the learning engine 525 can be stored in the model database 530. As illustrated in FIG. 5, the model database 530 may be included in the server memory 505 of the PTT server 150. It should be understood, however, that, in some configurations, the model database 530 may be included in one or more separate devices accessible by the PTT server 150 of FIG. 5 (including a remote database, and the like).

As one example, the learning engine 525 may develop a voice recognition model 540. The voice recognition model 540 may by an artificial intelligence or machine learning model trained to evaluate audio related data (e.g., the audio data, the metadata of the audio data, etc.) in order to determine contextual data related to audio data. As used herein, contextual data related to audio data may indicate or otherwise define a context (or a circumstantial context) in which audio data was captured. For example, the contextual data may indicate the circumstances or situation that form a setting for an event, such as, e.g., an event occurring while the audio data was captured. For instance, the context (or circumstantial context) of the audio data may indicate that the audio data was captured while a user of the UE 110 experienced distress or an emergency event. As one example, the context may indicate that the audio data was captured during an emergency event, such as a fire, an encounter with a bad actor or intruder, etc. Accordingly, in some configurations, the voice recognition model 540 may be developed to detect, based on audio data, an occurrence or presence of an emergency event. In some configurations, as described in greater detail herein, upon detecting such an emergency event, the technology disclosed herein (e.g., the voice recognition model 540) may trigger (or otherwise execute) an automated response protocol or action.

As described in greater detail herein, in some configurations, the voice recognition model 540 may be configured to extract one or more features or characteristics of the audio data (or the metadata thereof) in order to determine the context of the audio data (e.g., detect an emergency event). As noted herein, in some configurations, the UE 110 may extract the feature(s) of the audio data (as the metadata). However, in some configurations, the voice recognition model 540 may extract the feature(s) of the audio data. The feature(s) of the audio data may indicate (or otherwise facilitate a determination of) a context in which the audio data was captured. Accordingly, in some configurations, the voice recognition model 540 may determine the context of the audio data (or detect an emergency event) based on the feature(s), as described in greater detail herein.

As illustrated in FIG. 5, the server memory 505 may include one or more audio data databases 545. In the example of FIG. 5, the audio data database(s) 545 may store real-time data 550 and historical data 555. The real-time data 550 may include the audio data captured by the UE 110 and transmitted to the PTT server 150. Accordingly, in some configurations, upon receipt of the audio data from the UE 110, the server electronic processor 500 may store the audio data in the audio data database(s) 545 (e.g., as the real-time data 550). As noted herein, in some configurations, the audio data may be time series data. In such configurations, the audio data database(s) 545 may store the audio data based on a sliding window, such that memory resources are more efficiently utilized. As one example, the audio data database(s) 545 may store 10 minutes of audio data such that the most recent 10 minutes of data are stored as the real-time data 550 in the audio data database(s) 545.

The historical data 555 may include the metadata captured, historically for various users (or various UEs 110). In some configurations, the historical data 555 may include (or otherwise represent) user-specific audio data. For instance, in some configurations, the technology disclosed herein may monitor audio data for a particular user, determine a normalized (or baseline) voice pattern of that particular user, and store the normalized voice pattern of that particular user in association with an identifier of that particular user. As described in greater detail herein, such a normalized voice pattern for a user may be utilized or implemented when determining an occurrence of an emergency event (or circumstantial context of the audio data).

Alternatively, or in addition, in some configurations, the historical data 555 may include (or otherwise represent) a normalized voice pattern of an average user (e.g., a normalized voice pattern that is not specific to a particular user). In such configurations, the normalized voice pattern may be based on multiple users. For instance, the normalized voice pattern may be an aggregation (or compilation) of various voice features from various audio data associated with various users, wherein the normalized voice pattern represents a baseline trend or expected voice pattern across various users.

The server memory 505 may include additional, different, or fewer components in different configurations than illustrated in FIG. 5. Alternatively, or in addition, in some configurations, one or more components of the server memory 505 may be combined into a single component, distributed among multiple components, or the like. Alternatively, or in addition, in some configurations, one or more components of the server memory 505 may be stored remotely from the PTT server 150, or, in a remote database, another server, a remote user device, an external storage device, or the like. As one example, while the real-time data 550 and the historical data 555 are illustrated as being stored in the server memory 505, the real-time data 550 or the historical data 555 may be stored remotely from the PTT server 150 such that the real-time data 550 or the historical data 555 may be accessible by the PTT server 150.

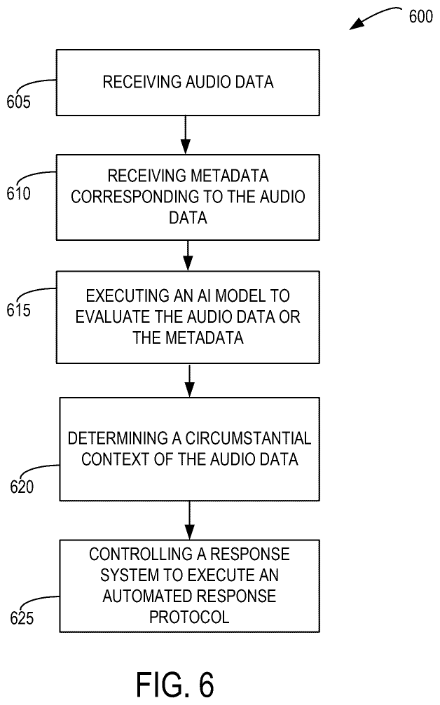

FIG. 6 is a flowchart illustrating an example method 600 to AI augmented voice recognition within telecommunications networks in accordance with some configurations. The method 600 is described as being performed by the PTT server 150 and, in particular, the server electronic processor(s) 500. However, as noted above, the functionality (or a portion thereof) described with respect to the method 600 may be performed by other devices, such as, e.g., another server or device within the telecommunications network 100, or distributed among a plurality of devices, such as a plurality of servers included in a cloud service. Thus, although described as begin performed by the PTT server 150, the method 600 may also be described as being performed by a processing system including one or more electronic processors (e.g., another processor or processors of the telecommunication network 100).

As illustrated in FIG. 6, the server electronic processor 500 may receive audio data (at block 605). Alternatively, or in addition, in some configurations, the server electronic processor 500 may receive metadata that corresponds to the audio data (at block 610). As noted herein, the audio data may be captured with the UE(s) 110 (e.g., via the microphone 445 thereof) and the metadata may be generated based on a preprocessing operation executed by the UE 110 (e.g., the UE electronic processor 405) with respect to the audio data. As described herein, in some configurations, the metadata may include, e.g., a tonal pitch of the audio data; a volume of the audio data; a word choice of the audio data; a word cadence of the audio data; a reverberation of the audio data; or another feature or characteristic of the audio data.

In some configurations, the server electronic processor 500 may receive the audio data, the metadata, or a combination thereof as an audio data package. In some instances, server electronic processor 500 may receive the audio data, the metadata, or a combination thereof from the UE 110 via a voice over new radio (VoNR) wireless communication standard. As noted herein, in some configurations, the audio data, the metadata, or a combination may be transmitted to the PTT server 150 (e.g., the server electronic processor 500) over a 5G telecommunications network (e.g., the telecommunications network 100) using VoNR.

In some configurations, the audio data, the metadata, or a combination may be time-series data. For example, in some instances, the audio data may be time-series data that is continuously captured by the microphone 445 of the UE 110. As such, in some configurations, the server electronic processor 500 may receive a data stream (e.g., an audio data stream) of time-series data (as the audio data). In some examples, the server electronic processor 500 may receive a data stream that includes the audio data (e.g., as raw data), the metadata corresponding to the audio data (e.g., as pre-processed data).

The server electronic processor 500 may execute the voice recognition model 540 (e.g., an AI model) to evaluate the audio data or the metadata (at block 615). For instance, in some configurations, the audio data or the metadata may be provided to the voice recognition model 540 as input. Responsive to receiving the audio data or the metadata the voice recognition model 540 may evaluate the audio data or the metadata to determine a circumstantial context of the audio data (e.g., detect an emergency event associated with the capture of the audio data), as described herein. Accordingly, in some configurations, the server electronic processor 500 may determine the circumstantial context of the audio data (at block 620). The server electronic processor 500 may determine the circumstantial context of the audio data based on execution of the voice recognition model 540.

In some examples, the voice recognition model 540 may evaluate the audio data or the metadata by extracting (or otherwise determining) one or more voice features from the audio data or the metadata. As noted herein, a voice feature (or an audio feature) may include, e.g., a tonal pitch of the audio data; a volume of the audio data; a word choice of the audio data; a word cadence of the audio data; a reverberation of the audio data; or another feature or characteristic of the audio data (or otherwise indicated by the metadata).

The voice recognition model 540 may determine a circumstantial context of the audio data based on the voice feature(s) (e.g., whether the voice feature(s) indicate an event, such as, an emergency event or situation). As described herein, in some configurations, responsive to determining that the voice feature(s) indicate an emergency event, the server electronic processor 500 may control execution of an automated response associated with the emergency event (or execute an automated response action), as described in greater detail herein.

In some configurations, the voice recognition model 540 may detect an emergency event (e.g., determine a circumstantial context of the audio data) when the voice feature(s) include (or otherwise indicate) a change or fluctuation in one or more of the voice feature(s) of the audio data, a presence of a particular voice feature, a deviation from a normalized voice pattern, etc. As one example, the voice recognition model 540 may detect an emergency event when the audio data or the metadata includes (or otherwise indicates) a sudden change in volume of the audio data (e.g., an increase in volume or a decrease in volume). As another example, the voice recognition model 540 may detect an emergency event when the audio data or the metadata includes (or otherwise indicates) a use or presence of one or more keywords or phrases in the audio data, such as, e.g., “help,” “please stop,” “call 911,” “fire,” “please don't hurt me,” etc. As yet another example, the voice recognition model 540 may detect an emergency event when the audio data or the metadata includes (or otherwise indicates) a deviation between a voice pattern of the audio data (e.g., a present voice pattern) and a normalized pattern (e.g., a baseline voice pattern).

In some examples, the voice recognition model 540 may detect an emergency event based on a single feature. As one example, when the audio data includes the word “help” or “call 911,” the voice recognition model 540 may detect an emergency event (e.g., a circumstantial context indicative of an emergency event). Alternatively, or in addition, in some configurations, the voice recognition model 540 may detect an emergency event based on multiple features. As one example, when the tonal pitch of the audio data and the volume of the audio data experience a sudden increase or decrease, the voice recognition model 540 may detect an emergency event (e.g., a circumstantial context indicative of an emergency event).

In some instances, the voice recognition model 540 may detect a change (or difference) between a present instance of a voice feature and a previous instance of a voice feature. The voice recognition model 540 may determine the circumstantial context (e.g., detect an emergency event) based on a comparison between various instances of one or more of the voice features. For instance, in some configurations, the voice recognition model 540 may determine the circumstantial context (e.g., detect an emergency event) based on whether there is a change (or difference) between the present instance and a previous instance of a voice feature. As one example, the voice recognition model 540 may determine whether a tonal pitch changed between instances of tonal pitch of the audio data. Alternatively, or in addition, the voice recognition model 540 may determine the circumstantial context (e.g., detect an emergency event) based on a magnitude of the change (or difference). As one example, the voice recognition model 540 may detect an emergency event when an increase or decrease amount exceeds a corresponding threshold (e.g., when a volume level changes by 5 levels). The voice recognition model 540 may determine the circumstantial context (e.g., detect an emergency event) based on whether that change (or difference) was an increase or decrease. As one example, the voice recognition model 540 may detect an emergency event when a particular feature exhibits an increase (e.g., an increase in volume) and may not detect an emergency event when a particular feature exhibits a decrease (e.g., a decrease in volume).

Accordingly, in some configurations, the voice recognition model 540 may access (or otherwise retrieve) previous (or historic) audio data or metadata (e.g., one or more previous instances of one or more of the voice features). For example, the voice recognition model 540 may access the historical data 555 from the audio data database(s) 545 of the server memory 505. The voice recognition model 540 may access the historical data 555 as part of evaluating the audio data or the metadata. In some configurations, the historical data 555 may include a normalized or baseline voice pattern. A normalized voice pattern may represent a trend or expected feature of the audio data with respect to various types of features. For example, with respect to tonal pitch (as a type of voice feature), a normalized voice pattern may indicate an expected tonal pitch (based on a trend of previous instances of tonal pitch). In some instances, a normalized voice pattern may represent a baseline of one or more types of voice features across a duration or period of time.

As noted herein, in some configurations, the voice recognition model 540 may detect an emergency event when the audio data or the metadata includes (or otherwise indicates) a deviation between a voice pattern of the audio data (e.g., a present voice pattern) and a normalized or baseline pattern (e.g., a normalized voice pattern), as represented via the historical data 555. Accordingly, in some configurations, the voice recognition model 540 may access the historical data 555 in order to determine (e.g., retrieve a preexisting normalized voice pattern or generate a normalized voice pattern) the normalized voice pattern such that the voice recognition model 540 may compare a present voice pattern with the normalized voice pattern and, ultimately, determine a circumstantial context (e.g., detect an emergency event) with respect to the present audio data (e.g., the present voice pattern).

As noted herein, in some configurations, a normalized voice pattern may be user specific. For instance, in some configuration, the server electronic processor 500 (e.g., the voice recognition model 540) may identify (or otherwise determine) an identity of a user (or entity) associated with the audio data (e.g., a user whose voice is captured as part of the audio data). In some configurations, the server electronic processor 500 may determine the identity of the user based on an identifier of the UE 110 at which the audio data was captured, where the UE 110 is associated with (or otherwise linked) to a particular user (e.g., a user account or profile). Alternatively, or in addition, in some configurations, the server electronic processor 500 may determine the identity of the user using voice recognition technology or techniques (e.g., applied to the audio data).

After the entity associated with the audio data is identified, the server electronic processor 500 may then determine (or otherwise select) a normalized voice pattern of the identified user. As one example, the server electronic processor 500 may retrieved (or otherwise access) a normalized voice pattern that corresponds to the identified user from the audio data database(s) 545 (e.g., the historical data 555 for or corresponding with the identified user. The server electronic processor 500 may determine a present voice pattern associated with the audio data based on the audio data or the metadata. In some examples, the server electronic processor 500 may determine a present voice pattern by determining or otherwise tracking trends or patterns for one or more voice features of the audio data (e.g., extracting and monitoring voice feature(s) of the audio data). The server electronic processor 500 may compare the normalized voice pattern with the present voice pattern in order to determine (or otherwise detect) a deviation between the normalized voice pattern of the user and the present voice pattern of the user. The server electronic processor 500 may determine the circumstantial context (or whether there is an emergency event) based on whether there is a deviation detected. In some examples, the server electronic processor 500 may compare individual voice features and determine whether there is a deviation between the individual voice features. As one example, the server electronic processor 500 may compare a tonal pitch of the present voice pattern to a tonal pitch of the normalized voice pattern in order to determine whether the tonal pitch of the present voice pattern deviates from the tonal pitch of the normalized voice pattern. When a voice feature of the present voice pattern deviates from a voice feature of the normalized voice pattern, the server electronic processor 500 may detect an emergency event or situation.

Accordingly, in some configurations, the voice recognition model 540 may perform (or otherwise execute) a tonal pitch analysis. The tonal pitch analysis may analyze a tonal pitch of the audio data in order to detect a fluctuation in tonal pitch (e.g., a change in tonal pitch). In some examples, the voice recognition model 540 may detect a change in tonal pitch that satisfies a pitch change threshold. In some configurations, the pitch change threshold may be with respect to a fluctuation amount for tonal pitch (e.g., an amount of change in tonal pitch between instances of tonal pitch). For example, the pitch change threshold may be satisfied when a magnitude of the fluctuation exceeds the pitch change threshold. Alternatively, or in addition, in some configurations, the pitch change threshold may represent a maximum or minimum tonal pitch, such that, when a present instance of tonal pitch exceeds the maximum or minimum tonal pitch, the voice recognition model 540 may detect an emergency situation. Alternatively, or in addition, in some configurations, the voice recognition model 540 may perform (or otherwise execute) a volume analysis. The volume analysis may monitor a volume level of the audio data in order to detect a change in volume level that satisfies a volume level threshold. The volume level threhsold may represent a magnitude of change or fluctuation in volume, a maximum or minimum volume level, etc. When the voice recognition model 540 detects a volume level (or change thereof) that satisfies the volume level threshold, the voice recognition model 540 may detect an emergency event. Alternatively, or in addition, in some configurations, the voice recognition model 540 may perform (or otherwise execute) a word choice analysis. The word choice analysis may monitor the audio data in order to detect an occurrence of a predetermined word or words (e.g., a phrase). When the voice recognition model 540 detects an occurrence of a predetermined word or words, the voice recognition model 540 may detect an emergency event.

In some configurations, the server electronic processor 500 (e.g., the voice recognition model 540) may determine a classification or status associated with a circumstantial context of the audio data. For instance, when the circumstantial context of the audio data indicates an emergency event, the server electronic processor 500 may determine a classification for the emergency event (e.g., for the audio data). A classification of the emergency event (or the audio data) may indicate a type of event, such as, e.g., a natural disaster classification (e.g., a tornado, an earthquake, etc.), a bad actor classification (e.g., a presence of an intruder or other bad actor, an altercation between users, etc.), an injury classification (e.g., a medical emergency, a type of injury to a user, etc.), a malfunction classification (e.g., a malfunction of equipment, a power outage, etc.), etc. Alternatively, or in addition, in some configurations, the classification of the emergency event (or the audio data) may indicate a severity or urgency of the emergency event, such as, e.g., an urgent classification, a moderate classification, a minor classification, etc.

In some configurations, the server electronic processor 500 may determine the classification based on the voice feature(s) of the audio data or the metadata. For example, in some configurations, the server electronic processor 500 (e.g., the voice recognition model 540) may determine the classification based on terminology or word choice. As one example, when the voice recognition model 540 detects the phrase “heart attack,” the voice recognition model 540 may detect an emergency event and classify the emergency event as an urgent medical emergency (as the classification for the emergency event). As another example, when the voice recognition model 540 detects the phrase “broken finger,” the voice recognition model 540 may detect an emergency event and classify the emergency event as a moderate emergency (as the classification for the emergency event). As yet another example, when the voice recognition model 540 detects a sudden decrease in tonal pitch and volume and the phrase “gun shot,” the voice recognition model 540 may detect an emergency event and classify the emergency event as an urgent bad actor emergency (as the classification for the emergency event).

The server electronic processor 500 may control a response system to execute an automated response protocol (at block 625). In some configurations, the server electronic processor 500 may control the response system based on the circumstantial context. In some instances, the server electronic processor 500 may control the response system responsive to the circumstantial context being indicative of an emergency event (e.g., responsive to detecting an emergency event). In some examples, the server electronic processor 500 may control the response system by executing an automated response pursuant to an automated response protocol. An automated response protocol may represent response guidelines given a set of predefined events or condition, such as, e.g., a mapping that associates a given event or condition to an automated response or action.

In some configurations, the automated response may include generation of an alert notification. In such configurations, the server electronic processor 500 may generate an alert notification responsive an emergency event. In some configurations, the alert notification may include (or otherwise indicate), e.g., an occurrence of an emergency event, at least a portion of the audio data (e.g., a portion related to the emergency event); at least a portion of the metadata (e.g., the voice feature(s) that triggered detection of the emergency event); a transcription of at least a portion of the audio data (e.g., a transcription of a portion of the audio data related to the emergency event); etc.

The server electronic processor 500 may broadcast (via, e.g., the alert notification) the emergency event (or information related thereto). In some examples, the server electronic processor 500 may broadcast the alert notification to nearby UEs 110 such that users of the nearby UEs 110 are informed of the emergency event. For example, the server electronic processor 500 may detect (or otherwise determine) one or more UEs 110 within a predetermined distance range of the UE 110 that captured the audio data associated with the emergency event. The server electronic processor 500 may then broadcast (or notify) those UEs 110 within the predetermined distance range of the emergency event. For example, the server electronic processor 500 may generate and transmit an alert notification to the UEs 110 within the predetermined distance range such that the UEs 110 within the predetermined distance range output the alert notification (e.g., as an audible alert, a visual alert, a haptic alert, etc.).

In some examples, the server electronic processor 500 may broadcast the emergency event (or information related thereto) to an emergency response system of an emergency response entity. For instance, in some configurations, the server electronic processor 500 may interface with a third-party response system or entity, such as, e.g., an emergency response organization or agency. For example, the server electronic processor 500 may generate and transmit the alert notification to an emergency response organization or agency. In such configurations, the server electronic processor 500 may transmit the alert notification as a next generation 911 (NG911) call, a short message service (SMS) notification, or another type of emergency alert notification.

In some configurations, the technology disclosed herein advantageously allows the PTT server 150 (e.g., the server electronic processor 500 or the voice recognition model 540) to leverage functionality of the 5GC 140. For instance, in some configurations, the PTT server 150 may access one or more NFs (e.g., the NF(s) 320 of FIG. 3) of the telecommunications network 100. For example, the PTT server 150 may access the NF(s) via an open application programming interface (API). When implemented within a cloud-based telecommunications network 100, the methods and systems disclosed herein enables access to 5G network functions or functionality, such as, e.g., functionality related to geographical location tracking, improved voice quality, low latency, near real-time communication, background noise reduction, etc., such that the PTT server 150 may execute such functionality with respect to the audio data to perform one or more functions as described herein (e.g., with respect to the method 600 of FIG. 6).

As one example, the PTT server 150 may determine, via the NF(s) of the telecommunications network (e.g., the 5GC 140), location data associated with the UE 110 that captured the audio data. The PTT server 150 (e.g., the server electronic processor 500) may control the response system to execute the automated response protocol based on the location data of the UE 110. For instance, the PTT server 150 may generate an alert notification that includes a location of the UE 110 that captured the audio data. As yet another example, the PTT server 150 may implement the NF(s) of the 5GC 140 in order to reduce background noise from the audio data received from the UE 110 to improve quality of the audio data such that an accuracy and performance of the voice recognition model 540 may be improved.

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A system to perform artificial intelligence (AI) augmented voice recognition within telecommunications networks, the system comprising:
a processing system including one or more electronic processors configured to:
receive, via a telecommunications network, audio data captured with a user equipment (UE), wherein the UE is a push-to-talk over cellular (PTToC) enabled device;
receive, via the telecommunications network, metadata that corresponds to the audio data, wherein the metadata is generated based on a preprocessing operation executed by the UE with respect to the audio data;
execute an AI model to evaluate the audio data and the metadata to determine a circumstantial context of the audio data;
determine, based on execution of the AI model, the circumstantial context of the audio data; and
control, based on the circumstantial context, a response system to execute an automated response protocol.

2. The system of claim 1, wherein the processing system is configured to:
determine that the circumstantial context is associated with an emergency event.

3. The system of claim 1, wherein the processing system is configured to control the response system to:
generate an alert notification that indicates at least one of:
occurrence of an emergency event;
a first portion of the audio data;
a second portion of the metadata; or
a transcription of the first portion of the audio data.

4. The system of claim 3, wherein the processing system is configured to control the response system to:
identify a second UE, wherein the second UE is located within a first distance range from the UE; and
transmit the alert notification to the second UE such that the second UE outputs the alert notification.

5. The system of claim 3, wherein the processing system is configured to control the response system to:
interface with an emergency response system of an emergency response entity.

6. The system of claim 1, wherein the metadata includes at least one of: a tonal pitch of the audio data; a volume of the audio data; a word choice of the audio data; a word cadence of the audio data; or a reverberation of the audio data.

7. The system of claim 1, wherein the telecommunications network is a fifth generation (5G) telecommunications network; and wherein the processing system is configured to receive the audio data via a voice over new radio (VoNR) wireless communication standard.

8. The system of claim 1, wherein the audio data is time-series data that is continuously captured by a microphone of the UE.

9. The system of claim 1, wherein the processing system is configured to:
access, via an open application programming interface (API), a network function of the telecommunications network.

10. The system of claim 9, wherein the processing system is configured to:
determine, via the network function, location data associated with the UE; and
control the response system to execute the automated response protocol based on the location data associated with the UE.

11. The system of claim 1, wherein the AI model is configured to evaluate the audio data and the metadata to determine the circumstantial context by performing at least one of:
a tonal pitch analysis that analyzes a tonal pitch of the audio data in order to detect a fluctuation in tonal pitch;
a volume analysis that monitors a volume level of the audio data in order to detect a change in volume level that exceeds a volume level threshold; and
a word choice analysis that monitors the audio data in order to detect an occurrence of a predetermined word.

12. The system of claim 1, wherein the processing system is configured to:
identify an entity associated with the audio data;
determine a normalized voice pattern of the entity;
determine, based on the audio data and the metadata, a present voice pattern of the entity;
detect a deviation between the normalized voice pattern of the entity and the present voice pattern of the entity; and
determine the circumstantial context based on the deviation.

13. A method to perform artificial intelligence (AI) augmented voice recognition within telecommunications networks, the method comprising:
receiving, with a processing system including one or more electronic processors, using a voice over new radio (VoNR), an audio data package, the audio data package including audio data captured with a push-to-talk (PTT) device, wherein the PTT device is a push-to-talk over cellular (PTToC) enabled device;
executing, with the processing system, an AI model to determine a circumstantial context of the audio data from the audio data package;
determining, with the processing system, that the circumstantial context of the audio data triggers an automated response protocol; and
executing, with the processing system, based on the circumstantial context, an automated response pursuant to the automated response protocol.

14. The method of claim 13, wherein receiving, with the processing system, using the VoNR, the audio data package includes receiving metadata that corresponds to the audio data, wherein the metadata is generated based on a preprocessing operation executed by the PTT device with respect to the audio data.

15. The method of claim 13, wherein receiving, with the processing system, using the VoNR, the audio data package includes receiving, from the PTT device using VoNR, a data stream that includes the audio data and metadata corresponding to the audio data, wherein the audio data is raw data and the metadata corresponding to the audio data is pre-processed data.

16. The method of claim 13, wherein determining, with the processing system, the circumstantial context of the audio data triggers the automated response protocol includes:
identifying, with the processing system, a previous instance of a feature of the audio data;
comparing, with the processing system, a present instance of the feature of the audio data with the previous instance of the feature of the audio data; and
determining, with the processing system, that the present instance of the feature of the audio data deviates from the previous instance of the feature of the audio data.

17. The method of claim 13, further comprising:
determining, with the processing system, a classification for the audio data based on the circumstantial context; and
selecting, with the processing system, the automated response from a plurality of automated responses based on the classification.

18. A non-transitory computer-readable medium storing instructions that, when executed by one or more electronic processors of a processing system in a telecommunications network, cause the processing system to perform operations comprising:
receiving, over a fifth generation (5G) telecommunications network, using voice over new radio (VoNR), audio data captured with a push-to-talk over cellular (PTToC) device;
receiving, over the 5G telecommunications network, using VoNR, metadata corresponding to the audio data;
providing the audio data and the metadata to an artificial intelligence (AI) model, the AI model configured to extract a plurality of voice features from the audio data and the metadata;
determining that one or more voice features of the plurality of voice features indicate an event; and
responsive to determining that the one or more voice features of the plurality of voice features indicate the event, controlling execution of an automated response associated with the event.

19. The computer-readable medium of claim 18, wherein determining that the one or more voice features of the plurality of voice features indicate the event includes at least one of:
detecting, in the audio data, a change in tonal pitch that satisfies a pitch change threshold;
detecting, in the audio data, a change in volume that satisfies a volume change threshold;
detecting, in the audio data, a use of a predetermined word; or
detecting, in the audio data, a deviation from a normalized voice pattern.

20. The computer-readable medium of claim 18, further comprising:
accessing, via an open application programming interface (API), a virtual network function of the 5G telecommunications network; and
executing, using the virtual network function, functionality of the virtual network function with respect to the audio data.
